(19) United States
(12) Patent Application Publication
(10) Pub. No.: US 2003/0088693 A1
(43) Pub. Date: May 8, 2003

(54) System and method for routing email messages to appropriate ones of geographically distributed email servers

(76) Inventors: Nancy C. Cheung, Saratoga, CA (US); Rupinder S. Kataria, San Francisco, CA (US)

Correspondence Address: HEWLETT-PACKARD COMPANY, Intellectual Property Administration, P.O. Box 272400, Fort Collins, CO, 80527-2400, US

(21) Appl. No.: 09/993,277

(22) Filed: Nov. 5, 2001

(51) Int. Cl. G06F 15/173

(52) U.S. Cl. 709/238; 709/206

(57) ABSTRACT

A system and method are disclosed which enable email messages to be routed to an email server determined to be appropriate for handling such email messages without requiring human intervention to accomplish such routing. According to one embodiment, a method is disclosed for routing email messages to an appropriate one of a plurality of distributed email servers without requiring human intervention for such routing. The method comprises receiving an email message at a first server, and executing software on the first server to autonomously determine characteristic information of a user having submitted information included in the email message. Software executes on the first server to autonomously select an appropriate one of a plurality of distributed email servers for receipt of the email message based at least in part on the determined characteristic information of the user, and the email message is routed to the selected email server.

### RELATED APPLICATION

This application is a continuation-in-part of co-pending and commonly assigned U.S. Patent Application [Attorney Docket No. 10005508-1] entitled “SYSTEM AND METHOD FOR ROUTING EMAIL MESSAGES TO APPROPRIATE ONES OF GEOGRAPHICALLY DISTRIBUTED EMAIL SERVERS,” that was filed on Oct. 31, 2001, the disclosure of which is hereby incorporated herein by refernece.

### TECHNICAL FIELD

The present invention relates generally to routing of communication to one of a plurality of geographically distributed communication devices determined to be proper for handling the communication, and more specifically to a system and method for receiving a message submitted by a user to a server, such as a web server, wherein the server autonomously routes such message to one of a plurality of geographically distributed email servers determined to be appropriate for handling the message based at least in part on a characteristic associated with such email server that corresponds to a characteristic of the user, such as the email server being located in a geographical location in which the language of such geographic location is common to that of the user.

### BACKGROUND

With the proliferation of communication networks, such as the Internet, various methods for communicating with individuals, companies, and other entities have been developed. A particularly popular communication network is the World Wide Web (commonly referred to simply as “the web”) portion of the Internet. As is well known in the art, entities, including individuals, companies, governmental agencies, non-profit organizations, and various others, commonly have web sites executing on web servers that are accessible by the public. More specifically, the web works on a client/server model in which client software, commonly known as a web browser, executes on a user's local computer, which may be any suitable processor-based device, including as examples personal computers (PCs), laptops, personal digital assistants (PDAs), and cellular telephones capable of accessing the Internet. The host, commonly referred to as a web server, is a suitable processor-based device (which may be any suitable server platform) that has software executing thereon for serving up web pages.

To access a particular web site, a user typically establishes an Internet connection with the user's local computer, and executes the web browser thereon. Within the web browser, the user may enter a Uniform Resource Locator (URL) for a location that the user wants to access, or click (e.g., with a pointer device, such as a mouse) a hyperlink to a desired location (which in turn links the user to a particular URL). Web servers have URLs that uniquely identify such web servers, much as a telephone number uniquely identifies a particular entity to which the number is assigned. URLs generally contain several parts. The first part details which Internet protocol to use, such as “http://” for Hypertext Transfer Protocol (“HTTP”).

The second part, which is commonly “www,” sometimes indicates what kind of Internet resource is being contacted. The third part, which may be “company_name.com,” can vary in length and identifies the web server to be contacted. A final part may be included that identifies a specific directory on the web server and a home page, document, or other Internet object, as examples. The web browser sends the requested URL to the Internet using HTTP, and Internet routers route the request to the identified web server. The web server receives the request using the HTTP protocol, and determines the specific document (or “page”) being requested. The server then finds the requested page (e.g., home page, document, or object) and sends the page back to the web browser client. The information is then displayed on the computer screen in the web browser.

An entity commonly includes a way to submit messages, such as emails, to the entity via its web site. As an example, companies often offer support on their web sites for the products that they sell. For instance, as part of the support provided on its web site, a company may provide answers to frequently asked questions, solutions to commonly encountered problems, and/or tips for using, repairing, and/or troubleshooting the company's products. Such web site may further allow a customer to submit a message (e.g., a question or description of a problem encountered) to the entity. As another example, companies often offer products for sale on their web sites, and such web sites may enable a customer to submit orders for products and/or questions about the products to the entity via its web site. Generally, software executing on the web server will format the message (e.g., request for support or product order) as an email and direct the email to an email address. Additionally, or alternatively, entities may provide an email address for receiving email messages. For instance, an email address “support@company_name.com” may be an email address to which messages (e.g., questions and/or descriptions of problems encountered) may be submitted to the product support branch of the company.

Once an email is submitted to an entity's email address, either via a web site or otherwise, the email is typically communicated to an email server, which may be any suitable processor-based device that is identified by such email address. Oftentimes an entity may have many email servers that are geographically distributed. For example, an entity may have a web site that allows customers to submit messages requesting support for the entity's products. For instance, the entity may manufacture and/or sell computer products, and customers may request support for such computer products via the entity's web site. In response to a user submitting such a request for support, the entity's web server commonly formats a message requesting support and sends the message as an email to a default email server. Once received at the default email server, a human resource (e.g., support personnel) is typically required to handle the email, which may require the human resource to manually reroute the email message to another of the entity's geographically distributed email servers determined to be appropriate for handling the email message.

Client applications are available in the existing art that may be executing on a client computer in a client-server environment to allow a user to create rules for handling email messages received at the client. For example, Microsoft Outlook is a well known application that may be executed on a client computer. Microsoft Outlook includes a “rules wizard” that allows a user to create a rule that may be applied automatically to received email messages. As examples, a rule may be created to perform certain action(s) upon the rule being satisfied for received email messages, such as deleting received email messages, assigning received email messages to a particular category, redirecting received email messages to a particular person or distribution list, and/or moving received email messages to a particular folder. Various conditions may be specified in a rule, and if such conditions are satisfied for a received email message, then the specified action(s) may be triggered for the email message (e.g., deleting the message, redirecting the message to another email address, etc.). Examples of conditions that may be utilized in a rule include whether a received message is from a particular sender and whether a received message includes certain text in its subject or body. Another client application that allows for such rules to be created for automatic handling of email messages received at a client computer is a software application commercially known as ExLife, which is available from ORNIC Technologies, Inc. While such applications are available in the existing art for use in handling email messages received at a client computer, applications are traditionally not implemented on the server computer for use in routing email messages to an appropriate email server.

To illustrate a common scenario of the prior art wherein email messages are required to be manually rerouted by human resources from a default email server to a proper one of other geographically distributed email servers, consider the following example. Suppose an entity maintains a web site that allows users to submit messages requesting support for the entity's products. Further suppose that the entity distributes its products globally, and therefore must provide global support for its products. As a result, suppose the entity establishes a plurality of geographically distributed email servers. For instance, an email server may be implemented in each country in which the entity sells its products. Support personnel within each country may receive email messages from their respective country's email server (e.g., the email server may route the email messages to computers of support personnel or support personnel may otherwise retrieve the email messages from the email server), and the support personnel respond to the received messages to provide the requested support (e.g., via email response, telephone call to the requesting customer, or otherwise).

Continuing with the above example, one of the geographically distributed email servers is typically implemented as a default email server to which all email messages are initially sent from the entity's web server. For example, an email server implemented in the United States (U.S.) may be made a default server, and upon a message being submitted to the web site, software executes on the web server to format the message into an email and send such email to the default email server in the U.S. Support personnel in the U.S. retrieve the email messages received at such default email server, and attempt to provide the requested support. However, such support personnel may determine that a received email is more appropriately handled by another of the entity's geographically distributed email servers (e.g., may determine that a support group of another country should handle a received email message). For example, suppose that the entity sells products in both Japan and the U.S., as well as various other countries. Further suppose that a customer in Japan submits a request for support (in Japanese language) to the entity's web site. As described above, such a message would be formatted into an email by the web server and sent to the default email server in the U.S. Support personnel in the U.S. must then manually review the received email, determine that it should be handled by the Japanese support personnel (e.g., to provide support in the proper language), and then manually route the email to the Japanese email server. More specifically, the web server may initially send all received email messages to the email server, which may have an email address of “support@us.company_name.com,” and upon determining that an email should be handled by the Japanese email server (e.g., by the Japanese support personnel), the U.S. support personnel must manually reroute the email to the Japanese email server, which may have an email address of “support@japan.company_name.com.”

It should be recognized that such a prior art implementation is inefficient and unnecessarily consumes human resources for routing email messages to an appropriate email server for handling. For instance, human resource time that could otherwise be spent addressing appropriate email messages (e.g., requests for support received from U.S. customers in the above example) is consumed by human resources being required to determine an appropriate email server and route email messages to such appropriate email server (e.g., Japanese email server in the above example). Accordingly, a desire exists for a system and method that enable email messages, such as those submitted to an entity's web site, to be routed to an appropriate one of distributed email servers for handling thereof in a more efficient manner and in a manner that does not require consumption of human resources.

### SUMMARY OF THE INVENTION

The present invention is directed to a system and method which enable email messages to be routed to an email server determined to be appropriate for handling such email messages without requiring human intervention to accomplish such routing. According to one embodiment of the present invention, a method is disclosed for routing email messages to an appropriate one of a plurality of distributed email servers for handling by personnel assigned to such appropriate one without requiring human intervention for such routing. The method comprises receiving an email message at a first server, and executing software on the first server to autonomously determine characteristic information of a user having submitted information included in the email message. The method further comprises executing software on the first server to autonomously select an appropriate one of a plurality of distributed email servers for receipt of the email message based at least in part on the determined characteristic information of the user, and executing software on the first server to autonomously route the email message to the selected email server.

According to another embodiment of the present invention, a system is disclosed that comprises a plurality of distributed email servers of an entity that are communicatively coupled to a communication network. The system further comprises a web server that is communicatively accessible by at least one processor-based device. The web server executes software thereon to present an interface for the entity to a user accessing the web server via a processor-based device, wherein the interface enables the user to interact therewith to convey information to the entity. At least one of the web server and the plurality of geographically distributed email servers executes software to autonomously route information conveyed to the entity from the user as an email message to a selected one of the plurality of distributed email servers determined to be appropriate for handling of the email message.

### BRIEF DESCRIPTION OF THE DRAWING

FIG. 1 shows an exemplary environment in which various embodiments of the present invention may be implemented;

FIG. 2A shows an exemplary flow diagram of the operation of a most preferred embodiment of the present invention;

FIG. 2B shows an exemplary flow diagram of the operation of an alternative embodiment of the present invention; and

FIG. 3 shows an exemplary flow diagram of the operation of one implementation of a most preferred embodiment of the present invention, wherein an appropriate one of a plurality of geographically distributed email servers is selected by an email server to which an email message from a user is routed in order to ensure that persons accessing such appropriate email server to handle the email message speak the same language as such user.

### DETAILED DESCRIPTION

Embodiments of the present invention enable email messages to be routed to an email server determined to be appropriate for handling such email messages without requiring human intervention to accomplish such routing. More specifically, a preferred embodiment provides a system and method for routing email messages to an appropriate one of a plurality of distributed email servers for handling by personnel assigned to such appropriate one without requiring human intervention to perform the routing. According to a preferred embodiment, an email message is received at a server, and software executes on such server to autonomously determine characteristic information of a user that submitted information included in the email message. The server further executes software to autonomously select an appropriate one of a plurality of distributed email servers for receipt of the email message based at least in part on the email server having a characteristic associated therewith that corresponds to the determined characteristic information of the user. The server further executes software to autonomously route the email message to the selected email server for handling of the email message by personnel assigned to the email server. The server may include memory storing such software code for autonomously selecting an appropriate email server to which an email message is to be routed. The term “memory” is used broadly herein and is intended to encompass, without limitation, disk drives, floppy disks, optical discs (e.g., Compact Discs (CDs) and Digital Versatile Discs (DVDs)), and random access memory (RAM), as well as any other suitable data storage devices now known or later discovered.

In a most preferred embodiment, an entity has implemented a web server and a plurality of geographically distributed email servers. A user accesses the entity's web server and submits information thereto. For example, a user may interact with an interface provided by the web server to submit information requesting support for a product purchased from the entity. The web server formats the information into an email message and transmits the message to a default email server. The web server may include with the message, additional characteristic information about the user, such as the user's home address, etcetera, which may be retrieved from a database of information and/or acquired from the user by the web server's interface. The default email server receives the email message and executes software thereon to autonomously determine the appropriate one of a plurality of geographically distributed email servers to which the email message should be routed for proper handling. Of course, it may be determined that the default email server is the appropriate email server for handling of the message, in which case no further routing of the message may be necessary. Otherwise, once the appropriate email server is determined, the default email server autonomously sends the received email message to such appropriate email server for handling.

In an alternative embodiment, once a user submits information to the web server, the web server may execute software to autonomously determine the appropriate one of a plurality of geographically distributed email servers to which the email message should be routed for proper handling. Once the appropriate email server is determined, the web server autonomously formats the information into an email message and sends the email message to such appropriate email server for handling.

Most preferably, software executes either on a web server or a default email server to autonomously determine an appropriate one of a plurality of geographically distributed email servers for receipt of an email message based at least in part on the email server having a characteristic associated therewith that corresponds to the determined characteristic information of the user. For example, it may be determined that the user speaks Japanese and/or lives in Japan, and it may therefore be determined that the most appropriate email server to which the email message should be routed is an email server located in Japan (rather than one located in the United States, for instance).

As described further below, a technical advantage of one aspect of a preferred embodiment of the present invention is that it enables information received at an entity's web server to be communicated as an email message to one of a plurality of geographically distributed email servers appropriate for handling the email message without requiring human intervention for such routing to the appropriate email server. Accordingly, more efficient routing of email messages and more efficient utilization of human resources may be recognized.

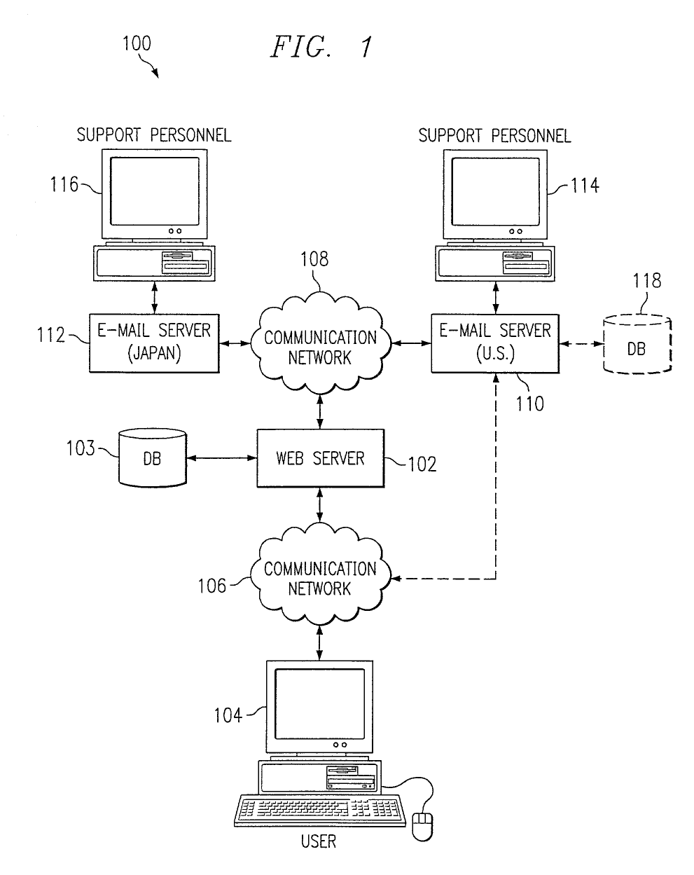

Turning to FIG. 1, an exemplary environment 100 in which various embodiments of the present invention may be implemented is shown. As shown, a web server 102 is included, which may be any suitable processor-based device for executing software to provide an entity's web site a presence on the world wide web. More specifically, web server 102 most preferably has a URL assigned thereto that uniquely identifies such web server, whereby users may access web server 102 to view and/or interact with web pages hosted by such web server 102. Software and programming techniques for implementing a web site (e.g., web pages, documents, objects, etcetera) on such a web server are well known in the art, and therefore will not be described in great detail herein. Of course, in alternative embodiments, rather than a “web” server, server 102 may be any other suitable server implemented in a client/server fashion for hosting an interface for an entity that is accessible by users (e.g., via a communication network) to enable such users to submit messages to the entity.

As further shown in FIG. 1, one or more network elements, such as computer 104, which is referred to broadly and is intended to encompass any suitable processor-based device such as a PC, laptop, PDA, and cellular telephone, as examples, are capable of communicatively accessing web server 102 via communication network 106. More specifically, computer 104 is preferably executing suitable client software, such as a web browser, to provide an interface that allows a user to access web server 102 (e.g., by inputting the appropriate URL or activating a hyperlink to web server 102). Communication network 106 may be any suitable type of communications network including as examples the Internet, an Intranet, an Extranet, a local area network (LAN), a wide area network (WAN), public switched telephone network (PSTN), wireless network, modem to modem connection, a combination of the above, or any other communications network now known or later developed within the networking arts which permits two or more computers to communicate with each other. Most preferably, communication network 106 is the Internet, and a user is capable of utilizing computer 104 to access web server 102 via the Internet.

Most preferably, web server 102 provides an interface with which a user may interact to submit a message to the entity for which the web site is provided. For instance, web server 102 may provide an interface that includes user-selectable text (e.g., text having associated therewith check-boxes or “radio controls” with which a user may interact to select such text) and/or text-entry box(es) in which a user may enter text. Thus, a user may interact with the web server's interface (e.g., utilizing the client software executing on computer 104) to complete a message to the entity. The web server's interface may include a “submit” button or like user-activated control, which when activated by a user (e.g., when a user clicks on such button with a pointer device, such as a mouse), the software executing on web server 102 recognizes such activation as an instruction to submit the message to the entity.

As shown in FIG. 1, web server 102 may have access to one or more databases (or other data storage devices), such as database 103, which may include various information therein. More specifically, database 103 may be as simple as a FileMaker Pro database or as complex as an Oracle SQL database, as examples, and web server 102 may, for instance, execute Common Gateway Interface (CGI) software (e.g., CGI scripts) to access such database 103 to search and retrieve information therefrom. Such CGI method of accessing databases from web sites is well known in the art, and therefore will not be described in greater detail herein. Of course, any other suitable method now known or later developed for enabling web server 102 to access database 103 may be similarly implemented, and any such implementation is intended to be within the scope of the present invention. Such database 103 may, for example, include information about a user submitting a message to the entity. For instance, the user may be a customer that is submitting a message requesting support with a product purchased from the entity, and database 103 may include information about such user, such as the user's name, address, telephone number, product purchased, etcetera.

Once a message is submitted by a user to web server 102 (e.g., once the user activates a “submit” button on the web server interface), software executes on web server 102 to format the message into an email that includes the information constructed by the user. For example, the email may include text for which the user has activated an associated check box, as well as text entered into text box(es) by the user on the web server's interface. The software may further include within the email or otherwise attach to the email other information, such as information about the user retrieved from database 103. Web server 102 then transmits the email via communication network 108 to an email server, such as email server 110 or email server 112, for handling by recipients at such email server. Such email servers may be any suitable processor-based device for executing software for receiving email messages directed thereto. More specifically, such email servers 110 and 112 most preferably each have unique email addresses. That is, such email servers 110 and 112 preferably each have a unique Internet Protocol (IP) address (e.g., 163.52.128.72) by which they may be accessed, and most preferably each have a unique Domain Name System (DNS) address (e.g., “support@us.company_name.com” and “support@japan.company_name.com,” respectively) that corresponds to the email server's respective IP address.

As with communication network 106, communication network 108 may be any suitable type of communications network including as examples the Internet, an Intranet, an Extranet, a local area network (LAN), a wide area network (WAN), public switched telephone network (PSTN), modem to modem connection, a combination of the above, or any other communications network now known or later developed within the networking arts which permits two or more computers to communicate with each other. Most preferably, communication network 108 is the Internet, whereby web server 102 is capable of sending email messages to an email server, such as email server 110 or email server 112, via the Internet.

As FIG. 1 illustrates, an entity may have various email servers implemented (e.g., email server 110 and 112), and such email servers may be geographically distributed. In the example of FIG. 1, email server 110 may be located in the U.S., and email server 112 may be located in Japan. As is further shown in FIG. 1, one or more processor-based devices 114 (e.g., PC, laptop, PDA, or other suitable processor-based device capable of accessing email server 110 and retrieving email messages) is capable of communicatively accessing email server 110 either directly or via a communication network (not shown) to retrieve email messages from email server 110. Likewise, one or more processor-based devices 116 (e.g., PC, laptop, PDA, or other suitable processor-based device capable of accessing email server 112 and retrieving email messages) is capable of communicatively accessing email server 112 either directly or via a communication network (not shown) to retrieve email messages from email server 112. For instance, support personnel of the entity may access their respective email servers to retrieve email messages requesting support.

As described above, in typical prior art configurations, one of such geographically distributed email servers would be designated as a default server to receive all email messages from web server 102, and a human resource (e.g., support personnel) would be required to manually sort through the email messages received at such default server and forward any that should properly be handled by another of the geographically distributed email server to such other server. For instance, in such a prior art configuration, email server 110 in the U.S. may be designated as a default server, which receives all email messages from web server 102. In this manner, suppose a user in Japan (and/or that speaks Japanese) submits a message requesting support to web server 102, which in turn formats the message into an email and sends the email to the default email server 110. Support personnel utilizing computer 114 retrieves the email message from email server 110, and determines that it should be sent to email server 112 in Japan for handling by the Japanese support personnel (e.g., to provide support in the proper language desired by the user requesting the support). Requiring such manual handling by human resources is an inefficient method of routing the email messages to the proper email server and is an inefficient utilization of human resource time.

In a preferred embodiment of the present invention, email messages from web server 102 are routed to the appropriate email server for handling without requiring such human intervention. In a most preferred embodiment, email messages are sent from web server 102 to a default email server (e.g., email server 110) much as in the above-described prior art implementation, and the default email server autonomously determines whether the email message should be routed to another of the geographically distributed email servers for proper handling and autonomously routes the email message to any such email server determined to be proper. As an example of operation of a most preferred embodiment, again suppose email server 110 in the U.S. is designated as a default server, which receives all email messages from web server 102. Further suppose a user in Japan (and/or that speaks Japanese) submits a message requesting support to web server 102, which in turn formats the message into an email and sends the email to the default email server 110. As described in greater detail hereafter, email server 110 autonomously determines that such email should be sent to Japanese email server 112 for proper handling. Most preferably such a determination is made based on email server 112 having associated therewith a characteristic that corresponds with a characteristic of the user (i.e., the user that submitted the request for support). For instance, it may be determined by email server 110 that the user speaks Japanese (and/or lives in Japan), and it may be determined by email server 110 that server 112 is the appropriate server for handling such email message because it is geographically located in Japan (and/or has support personnel capable of speaking Japanese that access email server 112).

To aid email server 110 in making a proper determination of the most appropriate email server for receiving an email message, web server 102 may include with the email message information about the user gathered by the web server's interface interacting with the user and/or from database 103. Such information may, for example, be included within the email message from web server 102, attached to such email message, or otherwise communicated to email server 110 in a manner that associates such information with the email message. Additionally or alternatively, database 118 may be communicatively accessible to email server 110, and such database 118 may include information such as described above for database 103, from which email server 110 may determine certain characteristic(s) of a user that submitted the request for support.

In an alternative embodiment of the present invention, web server 102 may be implemented to determine the appropriate email server for handling an email without requiring human intervention, and may route the email from web server 102 to the determined appropriate email server. In this manner, the email message may be routed to the appropriate email server directly from web server 102, rather than first routing the email message to a default email server (e.g., email server 110) which in turn autonomously determines an appropriate email server for handling and routes the message thereto (if necessary).

As an example of operation of such an alternative embodiment, again suppose a user in Japan (and/or that speaks Japanese) submits a message requesting support to web server 102. Software may execute on web server 102 to enable it to autonomously determine the appropriate one of the geographically distributed email servers of the entity (e.g., email servers 110 and 112) to which the message should be routed, and in turn such software executes to format the submitted message into an email and sends the email to the email server determined to be most appropriate for handling of such email message. In this example, web server 102 may autonomously determine that such email should be sent to Japanese email server 112 for proper handling. Most preferably such a determination is made based on email server 112 having associated therewith a characteristic that corresponds with a characteristic of the user (i.e., the user that submitted the request for support). For instance, it may be determined by web server 102 that the user speaks Japanese (and/or lives in Japan), and it may be determined by web server 102 that email server 112 is the appropriate server for handling such email message because it is geographically located in Japan (and/or has support personnel capable of speaking Japanese that access email server 112). To aid web server 102 in making a proper determination of the most appropriate email server for to which an email message should be routed, web server 102 may utilize information about the user gathered by the web server's interface interacting with the user and/or from database 103.

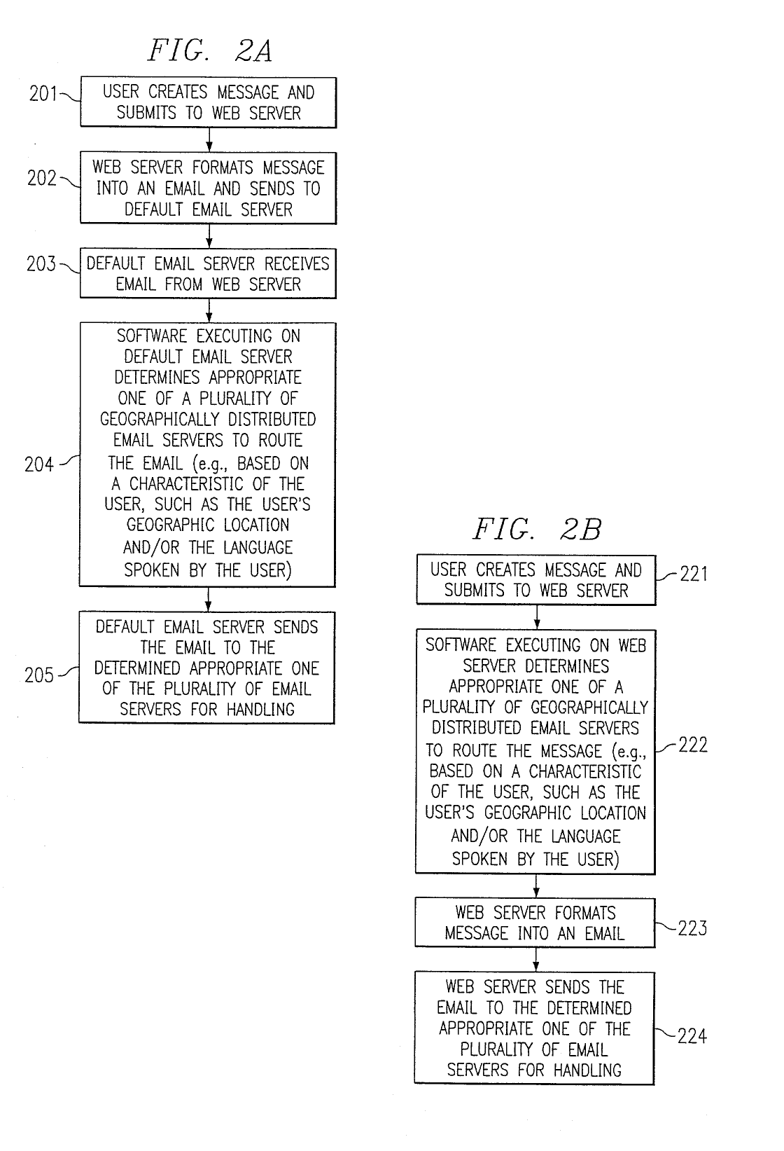

Turning to FIG. 2A, an exemplary flow diagram of the operation of a most preferred embodiment is shown. As shown in FIG. 2A, a user first creates a message and submits the message to the web server at operational block 201. More specifically, with reference to FIG. 1, a user may utilize computer 104 to interact with an interface on web server 102 to convey information to web server 102. Such information may be conveyed by interacting with tools, such as check boxes provided by the web server's interface and/or by providing text within one or more text boxes provided by the web server's interface, and a user may activate a “submit” button to submit the information to the web server, for example. In operational block 202, the web server formats the message (i.e., the conveyed information) into an email, and sends the email to a predetermined default email server. More specifically, with reference to FIG. 1, software executing on web server 102 formats the information conveyed to the web server's interface from a user into an email message, and communicates such email message to a predetermined default email server, such as email server 110, for example.

As mentioned above, web server 102 may include with the email message information (e.g., characteristic information) about the user gathered by the web server's interface interacting with the user and/or from database 103. Such information may, for example, be included within the email message from web server 102, attached to such email message, or otherwise communicated to the default email server in a manner that associates such information with the email message. Such information may aid the default email server in determining the most appropriate one of a plurality of email servers to receive the email message for handling by person(s) capable of accessing such appropriate email server. Additionally or alternatively, the default email server may be capable of determining characteristic information about the submitting user from the text and/or format of the email message. For example, the default email server may be capable of autonomously determining the user's language from the text of the email message.

In operational block 203, the default email server receives the email message from the web server. In block 204, software executing on the default email server determines the appropriate one of the geographically distributed email servers to route the email message for proper handling. Most preferably, the software executing on the default email server evaluates the received email message and/or any information associated therewith that is received from the web server to determine characteristic information about the submitting user, and the software executes to determine an appropriate one of the geographically distributed email servers having a corresponding characteristic associated therewith. For instance, the software executing on the default email server may determine based on information in the email message itself and/or associated information received from the web server that the user speaks Japanese (and/or lives in Japan). The software may further identify one of the geographically distributed email servers appropriate for handling the email. For example, the software may determine from a database, lookup table, or other type of stored information, which of the geographically distributed email servers is located in a geographical area that speaks Japanese or which of the geographically distributed email servers has support personnel assigned thereto for handling email messages that are capable of speaking Japanese. In response to such determination of the most appropriate email server for handling the email message, the software executes on the default email server to send, in operational block 205, the email to such email server determined to be most appropriate.

Turning now to FIG. 2B, an exemplary flow diagram of the operation of an alternative embodiment is shown. As shown in FIG. 2B, a user first creates a message and submits the message to the web server at operational block 221. More specifically, with reference to FIG. 1, a user may utilize computer 104 to interact with an interface on web server 102 to convey information to web server 102. Such information may be conveyed by interacting with tools, such as check boxes provided by the web server's interface and/or by providing text within one or more text boxes provided by the web server's interface, and a user may activate a “submit” button to submit the information to the web server, for example.

In operational block 222, software executing on the web server determines the appropriate one of the geographically distributed email servers to route the information received from the user. Most preferably, the software executing on the web server evaluates information input thereto from the user and/or information about the user stored in a database or other storage arrangement (e.g., database 103 of FIG. 1) to determine characteristic information about the submitting user, and the software executes to determine an appropriate one of the geographically distributed email servers having a corresponding characteristic associated therewith. For instance, the software executing on the web server may determine based on information received from the user and/or information stored in a database about such user that the user speaks Japanese (and/or lives in Japan). The software may further identify one of the geographically distributed email servers appropriate for handling the information received from the user. For example, the software may determine from a database, lookup table, or other type of stored information, which of the geographically distributed email servers is located in a geographical area that speaks Japanese or which of the geographically distributed email servers has support personnel assigned thereto for handling email messages that are capable of speaking Japanese. In response to such determination of the most appropriate email server for handling the email message, the software executes on the web server to format, in operational block 223, the information desired to be communicated to the entity from the submitting user, and sends, in operational block 224, the email to such email server determined to be most appropriate.

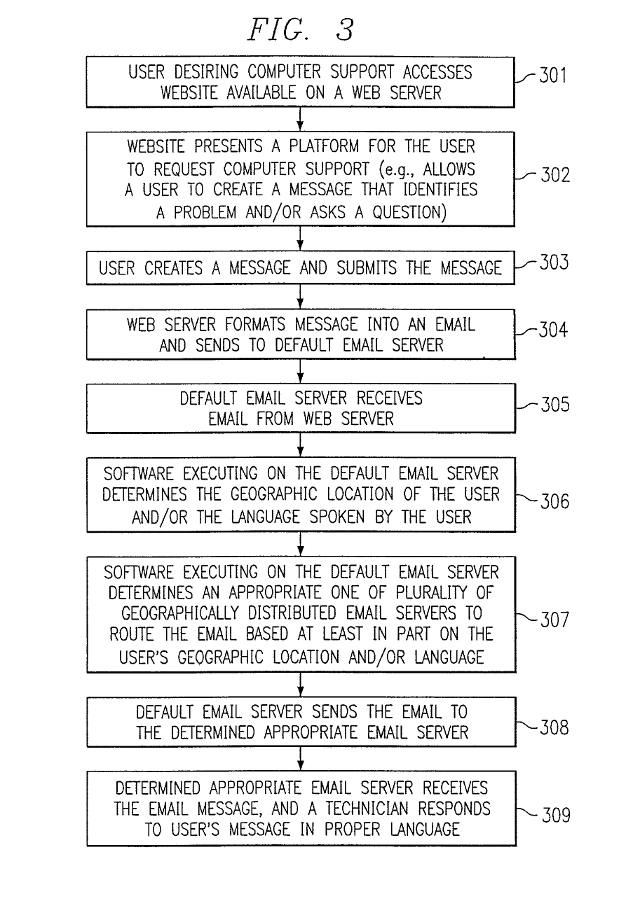

Turning now to FIG. 3, an exemplary flow diagram of the operation of one implementation of a most preferred embodiment of the present invention is shown. In the exemplary implementation of FIG. 3, an appropriate one of a plurality of geographically distributed email servers is selected by a default email server to which an email message from a user is routed in order to ensure that persons accessing such appropriate email server to handle the email message (e.g., support personnel) speak the same language as such user. As shown in FIG. 3, a user desiring support for a product from an entity (e.g., support for a computer product) accesses the entity's web site hosted by a web server in operational block 301. For instance, the user may utilize a web browser executing on the user's computer (e.g., computer 104 of FIG. 1) to access an entity's web site (e.g., via the URL for such web site or by activating a hyperlink to such web site). In operational block 302, the web site presents a platform (e.g., an interface) with which the user can interact to request the desired support (e.g., to request computer support). For instance, an interface may be presented that allows the user to convey information identifying the user's product and problem by, for example, entering text into text box(es) and/or selecting text on the interface (e.g., by activating a check box associated with such text). In operational block 303, the user interacts with such interface to effectively convey information to the web server (e.g., to create a message) requesting support and preferably detailing the type of problem encountered and/or support desired, and the user submits the information to the web server (e.g., by activating a “submit” button included on the interface).

In operational block 304, the web server formats the message (i.e., the submitted information) into an email, and sends the email to a predetermined default email server. More specifically, with reference to FIG. 1, software executing on web server 102 formats the submitted information into an email message, and communicates such email message to a predetermined default email server, such as email server 110, for example. As mentioned above, web server 102 may include with the email message information about the user gathered by the web server's interface interacting with the user and/or from database 103. Such information may, for example, be included within the email message from web server 102, attached to such email message, or otherwise communicated to the default email server in a manner that associates such information with the email message. Such information may aid the default email server in determining the most appropriate one of a plurality of email servers to receive the email message for handling by person(s) capable of accessing such appropriate email server. For example, database 103 may include information about the user that was gathered by the entity at the time that the user purchased the product for which support is now being requested, such as the user's address, telephone number, etcetera. Additionally or alternatively, the default email server may be capable of determining characteristic information about the submitting user from the text and/or format of the email message. For example, the default email server may be capable of autonomously determining the user's language from the text of the email message. For instance, software may be executing on the default email server that is capable of analyzing the text of the email message to determine that such message is in Japanese language, for example. Such language recognition software is known in the prior art, and any such language recognition software now known or later developed may be implemented on such default email server.

In operational block 305, the default email server receives the email message from the web server. In block 306, software executing on the default email server to determine the geographic location of the user and/or the language spoken by the user. Most preferably, the software executing on the default email server evaluates the received email message and/or any information associated therewith that is received from the web server to determine such characteristic information about the submitting user. For instance, the software executing on the default email server may determine based on information in the email message itself and/or associated information received from the web server that the user speaks Japanese (and/or lives in Japan).

In operational block 307, the software further determines an appropriate one of a plurality of geographically distributed email servers to route the email based at least in part on the determined characteristic information of the submitting user (e.g., based on the submitting user's language and/or geographic location). More specifically, the software preferably determines one of the plurality of email servers that has a characteristic associated therewith that corresponds to the determined characteristic information of the submitting user. For example, the software may determine from a database, lookup table, or other type of stored information, which of the geographically distributed email servers is located in a geographical area that speaks Japanese or which of the geographically distributed email servers has support personnel assigned thereto for handling email messages that are capable of speaking Japanese.

In response to such determination of the most appropriate email server for handling the email message, the software executes on the default email server to send, in operational block 308, the email to such email server determined to be most appropriate. In operational block 309, the determined appropriate email server (e.g., server 112 of FIG. 1) receives the email message routed from the default email server (e.g., server 110 of FIG. 1). Furthermore, in this exemplary implementation, personnel having access to the determined appropriate email server retrieve the email message therefrom and respond to the user's submitted message (e.g., a request for support) in the proper language. For instance, support personnel may utilize computer 116 to retrieve the email from the determined appropriate email server 112, and may respond in the proper language (e.g., Japanese) to the user in order to provide the requested support. Such response may be in the form a return email message to the user or in the form of a telephone call to the user, as examples.

Yet a further alternative embodiment may be implemented according to the present invention. Referring again to FIG. 1, a user may be capable of communicating an email message directly to an entity's email server without being required to access web server 102. Suppose, for example, that a company has a general email address for communication directed to the company (rather than a specific individual within the company). Such an email address may be identified by a DNS, such as “support@company_name.com” as an example, and such DNS may direct email to the IP address of one of the company's distributed email servers, such as email server 110. For instance, a user may utilize computer 104 to compose an email message to an entity. Computer 104 may access communication network 106 (e.g., the Internet, or other suitable network) to communicate the email message to the entity's email server 110, which is identified by the email address.

Upon the email message being received at email server 110 from the user's computer 104, software may execute on email server 110 to autonomously determine the appropriate one of the geographically distributed email servers to which the email message should be routed, much in the same way as described above for email messages received by the default email server from web server 102. However, as described above, when the messages are received through web server 102, additional information about the submitting user may be included with the email message. Because in this alternative embodiment the email message is received directly from a user, such additional information will likely not be included with the email message. Even so, email server 110 may execute software to analyze the software to autonomously determine the appropriate email server to route the email message. For example, email server 110 may execute software capable of language recognition to aid in determining the most appropriate email server to route the email. As another example, email server 110 may have information about the user stored in database 118, which may aid it in determining characteristic information about the user in order to select an appropriate email server for handling the message. For instance, software executing on email server 110 may look up information about the user in database 118 using the user's name and/or email address, which may be determined from the received email message.

Thus, suppose for example that the user is a customer in Japan that desires support for a product purchased from the entity. The user composes an email message in Japanese and directs it to the entity's general email address (e.g., the entity's global email address), which sends the email message to the default email server 110 in the U.S. Email server 110 has software executing thereon for autonomously determining the appropriate email server to route the email message. For instance, such software may analyze the text of the email message to recognize that it is in Japanese language. Additionally or alternatively, such software may lookup information about the user (e.g., which may have been obtained from the user when the user purchased the product from the entity) fiom database 118, whereby the software may determine that the user lives in Japan. Upon determining that the user lives in Japan and/or speaks Japanese, email server 110 may determine that email server 112 in Japan is the most appropriate for handling the email message, and may therefore autonomously route the email message to email server 112. Accordingly, a human resource assigned to email server 110 in the U.S. is not required to handle the email and direct it to the appropriate email server 112.

While an example of routing email messages to an appropriate one of geographically distributed email servers to provide customer/product support has been utilized in much of the above description, it should be understood that the various embodiments of the present invention are intended to encompass a much broader range of application beyond customer/product support. Thus, while customer/product support has been recognized as the most preferred implementation of the various embodiments, such embodiments may be implemented within other applications in which it is desirable to route email messages to an appropriate one of a plurality of different email servers of an entity without requiring human intervention for such routing. As one exemplary application, various embodiments of the present invention may be utilized to route email messages for purchase requests submitted to an entity's web site to appropriate manufacturing/shipment email servers. For instance, a user may access an entity's web site and submit a purchase order for a product, and the web server may format the purchase order into an email message directed to a default email server. The default email server, upon receiving the email message, may determine the most appropriate email server of various different manufacturing/shipment locations to route the email message. For example, it may be determined that the submitting user lives in Japan, and the email message may therefore be routed to an email server at a manufacturing/shipment facility in Japan, rather than one in the U.S. By routing the email message to the email server of the manufacturing/shipment facility located nearest to the user, shipment cost and/or time may be reduced.

It should be recognized that while the geographic locations utilized in many of the examples herein are Japan and the United States, any geographic locations may be utilized. For example, any countries and/or any states therein (or any other suitable geographically designated locations) may be utilized, and any such geographic locations are intended to be within the scope of the present invention. It also should be understood that while much of the above examples select an appropriate email server based on such server being in a geographic location and/or having personnel assigned thereto that speak the same language as the submitting user, other characteristics may be utilized for determining an appropriate email server in various implementations of the present invention.

What is claimed is:

1. A method of routing email messages to an appropriate one of a plurality of distributed email servers for handling by personnel assigned to such appropriate one without requiring human intervention for said routing, the method comprising:
receiving an email message at a first server;
executing software on said first server to autonomously determine characteristic information of a user having submitted information included in said email message;
executing software on said first server to autonomously select an appropriate one of a plurality of distributed email servers for receipt of said email message based at least in part on said determined characteristic information of said user; and
executing software on said first server to autonomously route said email message to the selected email server.

2. The method of claim 1 wherein said first server is a web server.

3. The method of claim 1 wherein said first server is an email server.

4. The method of claim 3 wherein said first server is a default email server to which email messages are sent from a web server.

5. The method of claim 1 further comprising:
said user submitting information to a web server; and
said web server creating an email message to communicate the submitted information to said first server.

6. The method of claim 1 wherein said characteristic information of said user includes identification of at least one language of said user.

7. The method of claim 1 wherein said characteristic information of said user includes identification of a geographical location of said user.

8. The method of claim 7 wherein said identification of a geographical location of said user identifies a country.

9. The method of claim 1 wherein said executing software on said first server to autonomously select an appropriate email server further comprises:
selecting said appropriate email server based at least in part on said appropriate email server having a characteristic associated therewith that corresponds to the determined characteristic information of said user.

10. The method of claim 9 wherein said characteristic information of said user includes identification of at least one language of said user, and wherein said characteristic associated with the selected email server includes identification of the geographical location of the selected email server as a geographical location in which the language common therein corresponds to the at least one language of said user.

11. The method of claim 9 wherein said characteristic information of said user includes identification of at least one language of said user, and wherein said characteristic associated with the selected email server includes the selected email server having personnel assigned thereto that are capable of communicating in a language common to said at least one language of said user.

12. The method of claim 9 wherein said characteristic information of said user includes identification of a geographical location of said user, and wherein said characteristic associated with the selected email server includes identification of the geographical location of the selected email server as a geographical location that corresponds to the geographical location of said user.

13. The method of claim 1 wherein said characteristic information of said user includes information available from a database.

14. The method of claim 1 wherein said characteristic information of said user includes information conveyed to a web server from said user.

15. A server for autonomously routing email messages received thereby to an appropriate one of a plurality of geographically distributed email servers for handling by personnel assigned to such appropriate one, the server comprising:
communicative coupling to a communication network over which an email message is received;
memory storing computer executable software code;
processor for executing said software code to autonomously determine characteristic information of a user having submitted information included in said email message received via said communicative coupling, for executing said software code to autonomously select an appropriate one of a plurality of distributed email servers for receipt of said email message based at least in part on the determined characteristic information of said user, and for executing said software code to autonomously route said email message to the selected email server.

16. The server of claim 15 wherein said communication network is selected from the group consisting of:
the Internet, an Intranet, an Extranet, a local area network (LAN), a wide area network (WAN), public switched telephone network (PSTN), wireless network, modem to modem connection, and any combination thereof.

17. The server of claim 15 wherein said selected email server is selected based at least in part on said selected email server having a characteristic associated therewith that corresponds to the determined characteristic information of said user.

18. The server of claim 17 wherein said characteristic information of said user includes information identifying at least one language in which said user can communicate, and wherein said characteristic associated with the selected email server includes information identifying that the selected email server is located in a geographic location in which at least one of said at least one language in which said user can communicate is common to said geographic location.

19. A system comprising:
plurality of distributed email servers of an entity communicatively coupled to a communication network;
web server communicatively accessible by at least one processor-based device, said web server executing software thereon to present an interface for said entity to a user accessing said web server via said at least one processor-based device, wherein said interface enables said user to interact therewith to convey information to said entity; and
at least one of said web server and said plurality of geographically distributed email servers executing software to autonomously route information conveyed to said entity from said user as an email message to a selected one of said plurality of distributed email servers determined to be appropriate for handling of said email message.

20. The system of claim 19 wherein at least one of said web server and said plurality of distributed email servers is operable to autonomously select said selected one of said plurality of distributed email servers based at least in part on a characteristic associated with the selected email server corresponding to a characteristic identified for said user.
